(19) United States
(12) Patent Application Publication
(10) Pub. No.: US 2012/0019509 A1
(43) Pub. Date: Jan. 26, 2012

(54) ELECTROPHORETIC DISPLAY AND PICTURE UPDATE METHOD THEREOF

(75) Inventors: CHIA-HUNG WEI, MIAOLI COUNTY (TW); WEN-YUAN KUO, MIAOLI COUNTY (TW); HSIANG-TSUNG CHUANG, MIAOLI COUNTY (TW)

(73) Assignee: FITIPOWER INTEGRATED TECHNOLOGY INC., MIAOLI COUNTY (TW)

(21) Appl. No.: 13/167,313

(22) Filed: Jun. 23, 2011

(30) Foreign Application Priority Data
Jul. 23, 2010 (TW) 099124352

(51) Int. Cl. G09G 3/34; G06F 3/038

(52) U.S. Cl. 345/213; 345/107

(57) ABSTRACT

For picture updating, an electrophoretic display erases the ghost image and then continuously turns on a plurality of frames, each for changing only one gray level, so as to gradually adjust each of the pixels to a respective desired gray level, which can simplify and accelerate the picture updating, and reduce the content size of a lookup table. By incorporating with adjusting the time length of the frames, the lightness adjustment of the electrophoretic display can be simplified.

### FIELD OF THE INVENTION

The present invention is related generally to an electrophoretic display (EPD) and, more particularly, to a picture update method of an EPD.

### BACKGROUND OF THE INVENTION

As compared with other types of displays, an EPD advantageously has lower power consumption while disadvantageously requires a more complicated driving process. In further detail, for an EPD to change a pixel from a gray level to another, the driving signal is determined not only depending on the target gray level, but also depending on the current gray level, for example, see Mark T. Johnson, Guofu Zhou, Robert Zehner, Karl Amundson, Alex Henzen and Jan van de Kamer, “High Quality Images on Electronic Paper Displays,” SID 05 Digest 1666 (2005).

Taking an active-matrix EPD system as shown in FIG. 1 for instance, for updating a picture of an EPD 10, a host 12 delivers the new picture to a timing controller 14, and the timing controller 14 stores the new picture and the old picture both in a memory 16, then searches a flash memory 18 for the driving waveform corresponding to the new and old gray level values of each pixel of an EPD panel 20 that was defined and stored in the flash memory 18 in advance, and generates a control signal according to the driving waveforms for the EPD panel 20, which has a row driver 22 to sequentially drive row electrodes 24 one by one, and a column driver 26 to provide specific driving voltages according to the control signal for column electrodes 28. In the EPD panel 20, at each intersection of a column electrode 24 and a row electrode 28 there is a pixel 30, with a thin film transistor 32 whose gate, source and drain are connected to the row electrode 24, the column electrode 28 and a pixel electrode of the pixel 30, respectively, so as to selectively apply a driving voltage to the pixel 30 to generate an electric field to drive electrophoretic particles of the pixel 30 to move, thereby having the pixel 30 brighter or darker. Taking a microcapsule dual particle system as shown in FIG. 2 for instance, microcapsules 38 are sandwiched between two parallel electrodes 34 and 36, each microcapsule 38 containing suspending black particles 40 and white particles 42 that carry opposite charges, and thus applying a driving voltage V between the electrodes 34 and 36 will drive the black particles 40 and the white particles 42 to move in opposite directions, respectively. The closer are the black particles 40 to the viewing side, for example at the electrodes 34, the blacker the pixel 30 is. On the contrary, the closer are the white particles 42 to the viewing side, the whiter the pixel 30 is. In this way, different gray levels can be represented by controlling the displacement of the black particles 40 and the white particles 42. The displacement of the black particles 40 and the white particles 42, and thus the optical variation derived therefrom, are positively correlated to the integration of the driving voltage V to time (referred to as a voltage pulse), for example, see Robert Zehner, Karl Amundson, Ara Knaian, Ben Zion, Mark Johnson and Guofu Zhou, “Drive Waveforms for Active Matrix Electrophoretic Displays,” SID 03 Digest 842 (2003). Referring to FIG. 1 again, all the driving waveforms for changing each pixel 30 from any gray level to any other are stored in the memory 18 in the form of a lookup table for the timing controller 14 to access thereto, for example, see Holly Gates, Takahide Ohkami and Yun Shon Low, “High Performance Active Matrix Electrophoretic Display Controller,” SID 08 Digest 693 (2008). For example, in a sixteen gray level system, referring to FIG. 3, to each pixel there would be sixteen gray levels possible for an start state and sixteen gray levels possible for a target state, so there will be 16×16=256 forms possible for change of gray level, and consequently 256 driving waveforms are required. In existing EPD systems, as shown in FIG. 4, the driving method is to drive the electrophoretic particles with N frames so as to move the electrophoretic particles from their current position to the position corresponding to the target gray level, in which process the electrophoretic particles are repeatedly driven forward and backward, finally moving to the position corresponding to the target gray level gradually. This driving method is very complicated and requires much time, and also consumes more power as the number of the frames is large.

In addition, if the driving waveform of a frame needs 2 bits of storage capacity, the lookup table will require a memory size of 256×N×2÷8=64N bytes, which will be dramatically increased with the increasing number of gray levels. Moreover, the properties of the material change with temperature, thereby requiring the lookup table to store multiple sets of driving waveforms for different thermal conditions, for example, see Holly Gates, Takahide Ohkami and Yun Shon Low, “High Performance Active Matrix Electrophoretic Display Controller,” SID 08 Digest 693 (2008), which further bulks the lookup table in size.

Due to difference between materials, a set of driving waveforms for change of gray level can not apply to all EPD panels, and thus each batch of EPD products requires individual setting of the lookup table, which is unfavorable to mass production.

The aforementioned driving method is also adverse to lightness adjustment of an EPD panel. Since the lightness of the EPD panel is determined by the position of the electrophoretic particles, all the driving waveforms have to be updated if to change the lightness difference between the gray levels.

### SUMMARY OF THE INVENTION

An objective of the present invention is to provide an EPD and picture update method thereof.

Another objective of the present invention is to provide a faster picture updating EPD and method.

Yet another objective of the present invention is to provide a lower power consumption EPD and picture update method.

Still another objective of the present invention is to provide an EPD and picture update method requiring smaller lookup table.

A further objective of the present invention is to provide an EPD and picture update method with simplified lightness adjustment.

According to the present invention, an EPD includes an EPD panel, a timing controller connected to the EPD panel, and a flash memory connected to the timing controller. The flash memory stores all driving waveforms for changing one gray level in the form of a lookup table. When updating a picture, the EPD erases the ghost image first, and then continuously turns on a plurality of frames, in each of the frames only changing one gray level, to gradually adjust all pixels to respective desired gray levels.

Since only one gray level is changed in each frame, the picture updating is simplified and requires fewer frames, thereby speeding up the picture updating and lowering power consumption. Further, since only the driving waveforms for changing one gray level are stored, the lookup table has dramatically reduced size. Moreover, by using the disclosed driving method, the lightness difference between gray levels can be easily adjusted by changing the frequency of the system clock.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is an active-matrix EPD system;

FIG. 2 is a microcapsule dual particle system;

FIG. 3 is a perspective diagram showing the possible changes between two gray levels in a sixteen gray level system;

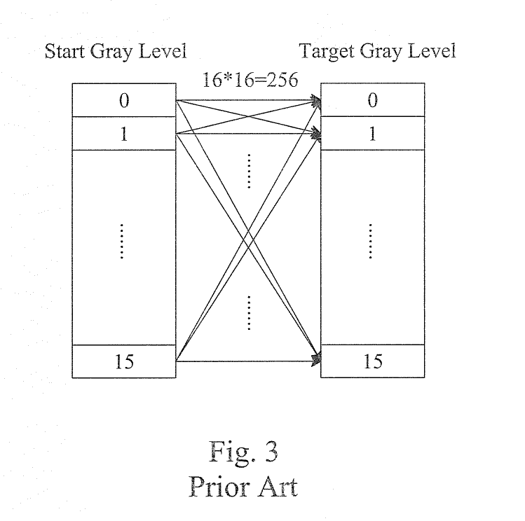

FIG. 4 is a perspective diagram showing a conventional driving method of an EPD;

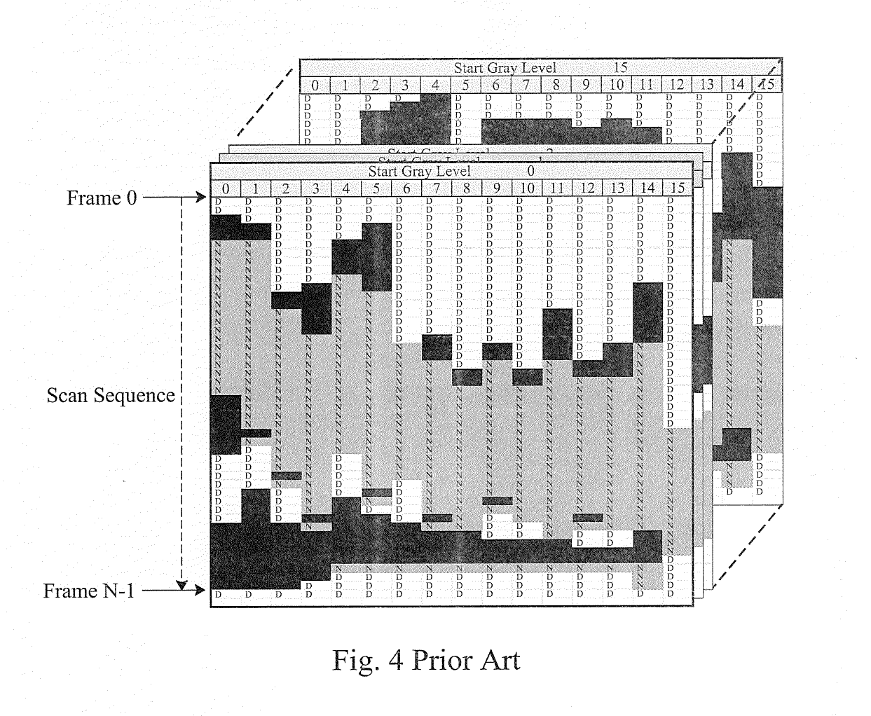

FIG. 5 is a perspective diagram showing relationship of lightness variation to pulse length under different voltages;

FIG. 6 is a flowchart of a picture update method in an embodiment according to the present invention;

FIG. 7 is a perspective diagram showing alignment of all pixels to a same gray level;

FIG. 8 is a perspective diagram showing a process of adjusting a pixel to gray level 15;

FIG. 9 is a perspective diagram showing a process of adjusting a pixel to gray level 3;

FIG. 10 is a perspective diagram showing a process of adjusting a pixel to gray level 0;

FIG. 11 is a perspective diagram showing a process of bidirectional adjustment of gray levels;

FIG. 12 is an EPD with adjustable lightness difference between gray levels; and

FIG. 13 is a perspective diagram showing two system clock frequencies.

### DETAILED DESCRIPTION OF THE INVENTION

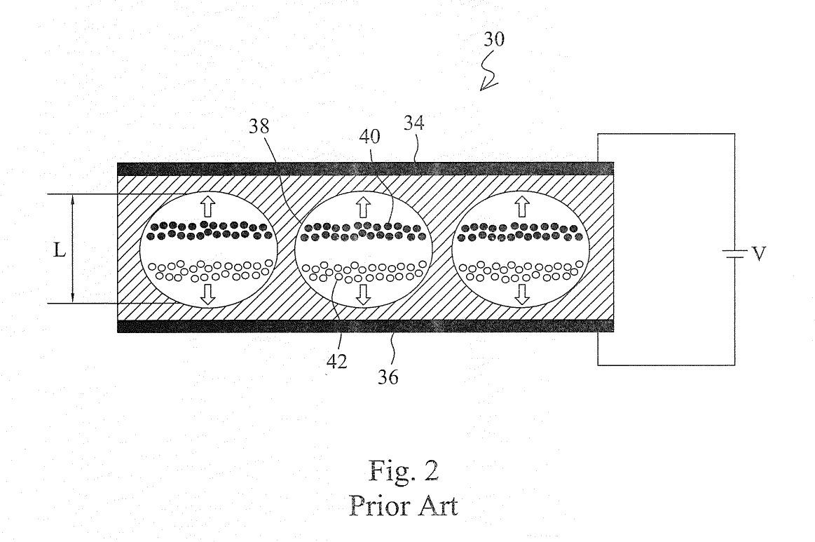

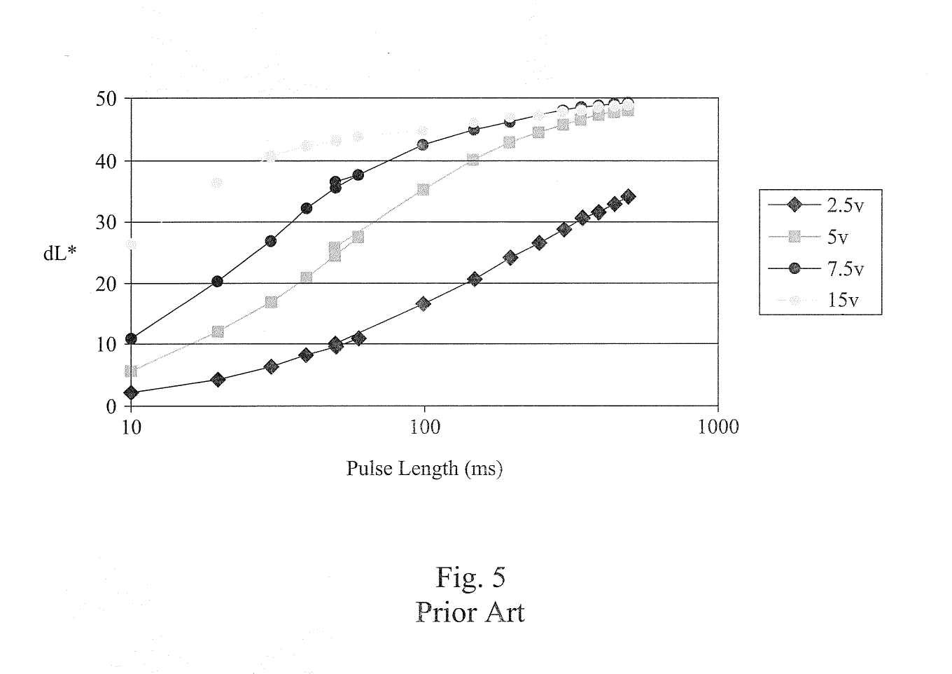

As shown in FIG. 2, the displacement dL of the electrophoretic particles 40 and 42 is a function of the driving voltage V and the time interval with the driving voltage V applied thereto, for example, see Robert Zehner, Karl Amundson, Ara Knaian, Ben Zion, Mark Johnson and Guofu Zhou, “Drive waveforms for active matrix electrophoretic displays,” SID 03 Digest 842 (2003), and thus it may program the voltage pulse for changing one gray level in advance. For example, FIG. 5 is a perspective diagram showing relationship of lightness variation to pulse length under different voltages, disclosed by Thomas Whitesides, Michael Walls, Richard Paolini, Sam Sohn, Holly Gates Michael McCreary and Joseph Jacobson, “Towards video-rate micro-encapsulated dual-particle electrophoretic displays,” SID 04 Digest 133 (2004), in which the pulse length represents the time interval that the driving voltage is applied, and L* is a unit of lightness defined in the CIELAB standard. From FIGS. 2 and 5, a gray level may be determined by

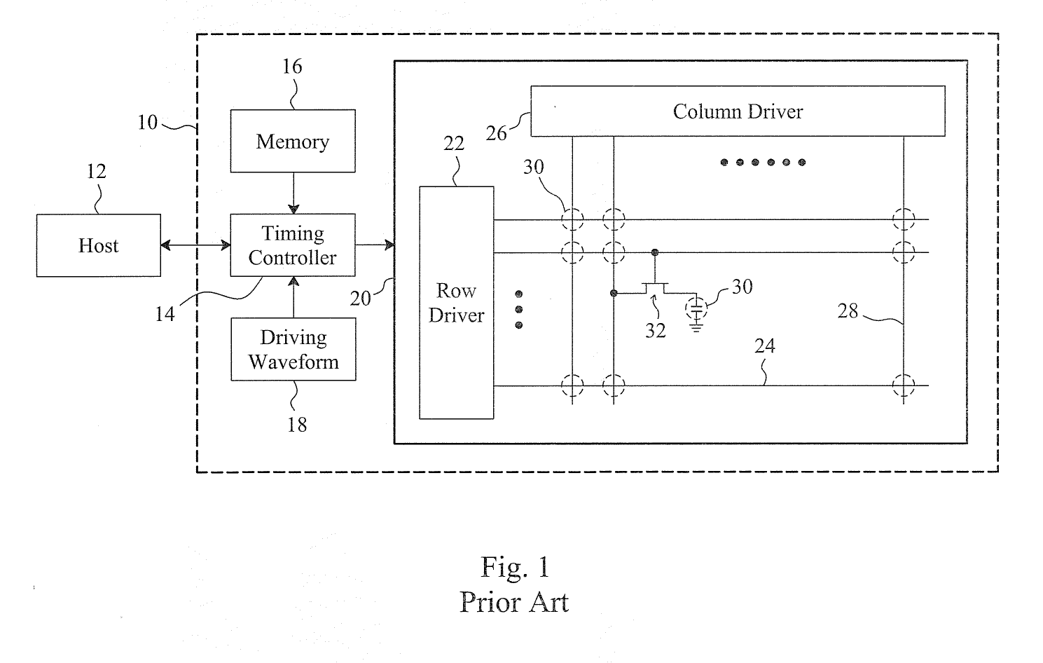

dL*=v×t=kV×t, [Eq-1]

where v is the moving velocity of the electrophoretic particles 40 and 42. Ideally, the lightness variation dL* is proportional to the moving time t of the electrophoretic particles 40 and 42, i.e. k is a constant. In fact, however, the characteristic curve of dL* is not linear, as can be seen in FIG. 5. Yet, each voltage pulse for changing one gray level can be defined from the characteristic curve of dL*, for example, the required pulse length t under a certain driving voltage V, and based thereon, all driving waveforms required to change one gray level are stored in the flash memory 18 of FIG. 1. When adjusting the gray level of the pixels 30, a plurality of frames are continuously turned on to apply the corresponding driving waveforms to the pixel 30, in each frame only changing one gray level, until the pixel 30 reaches the desired gray level.

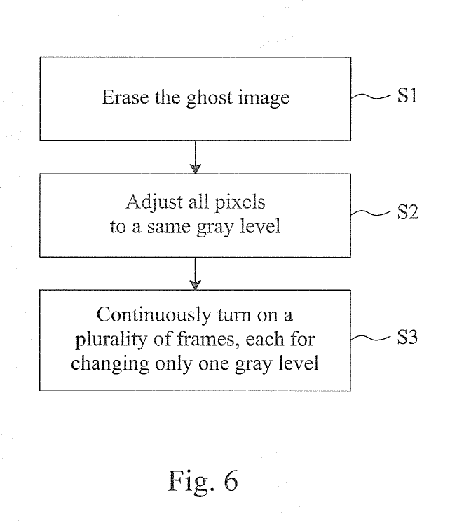

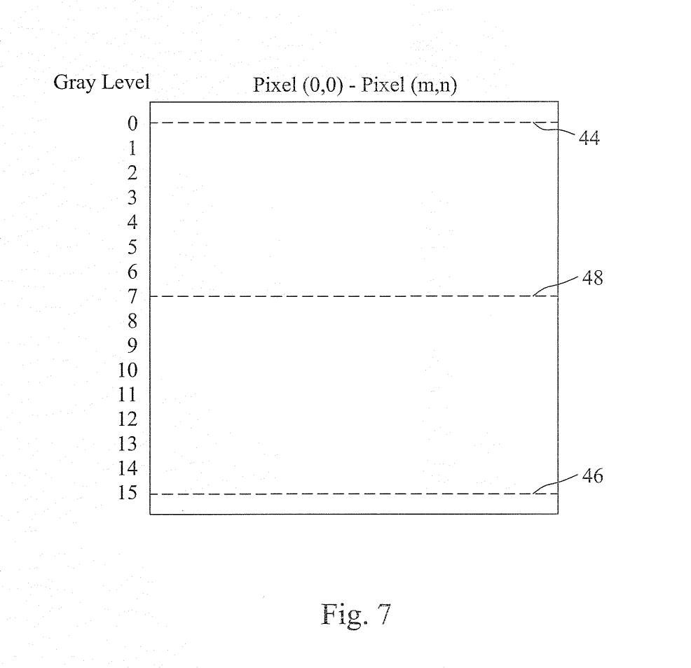

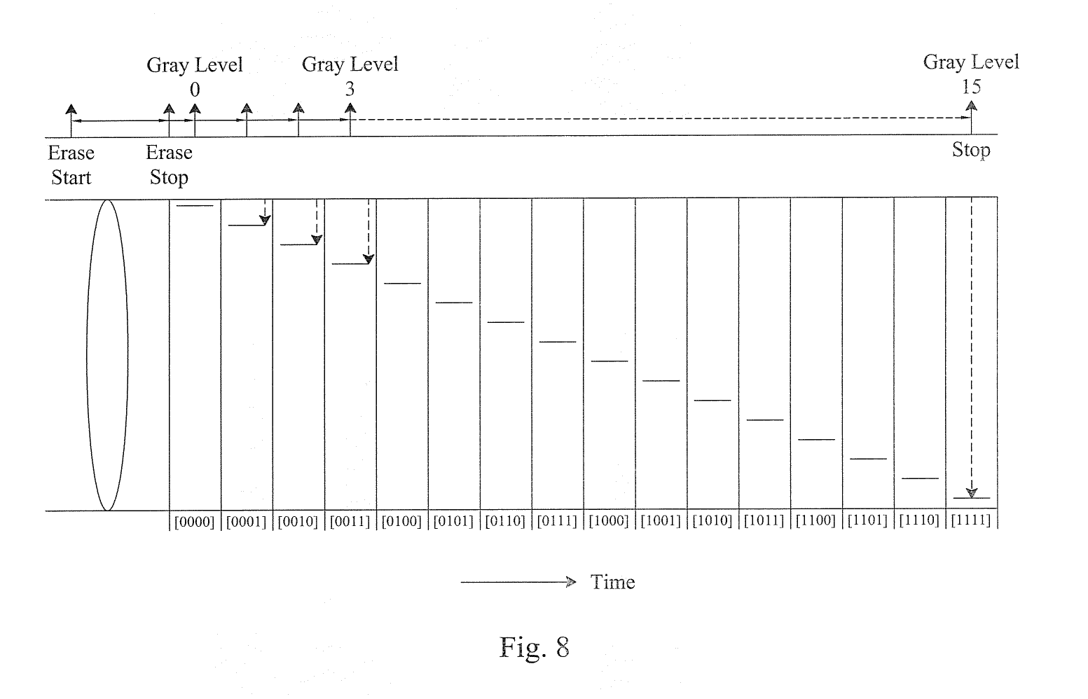

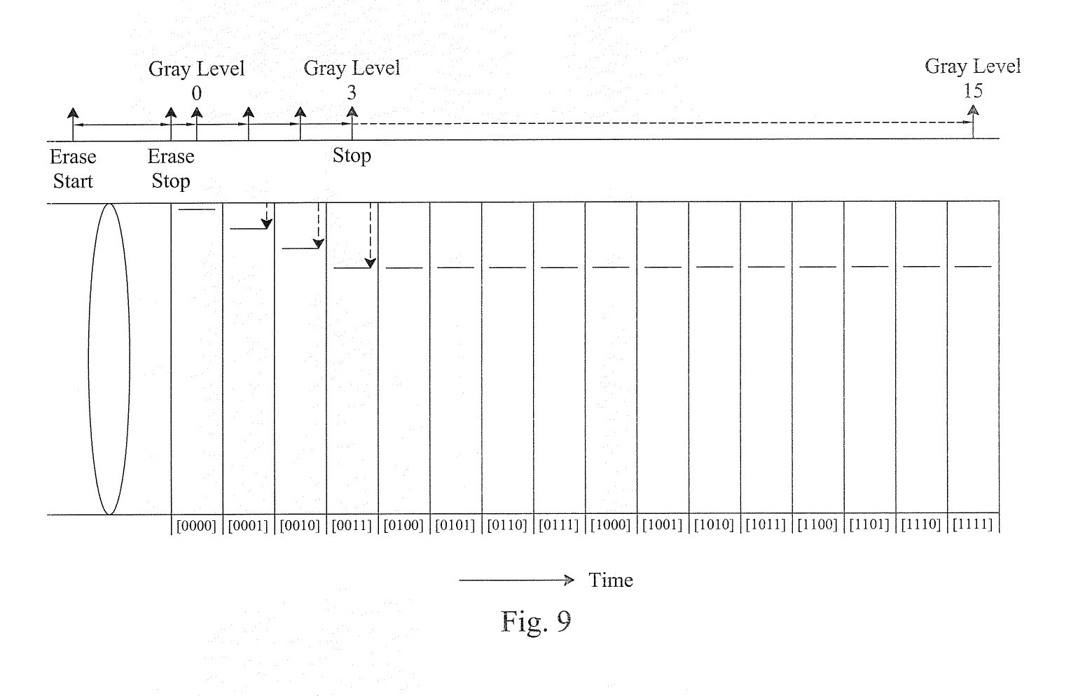

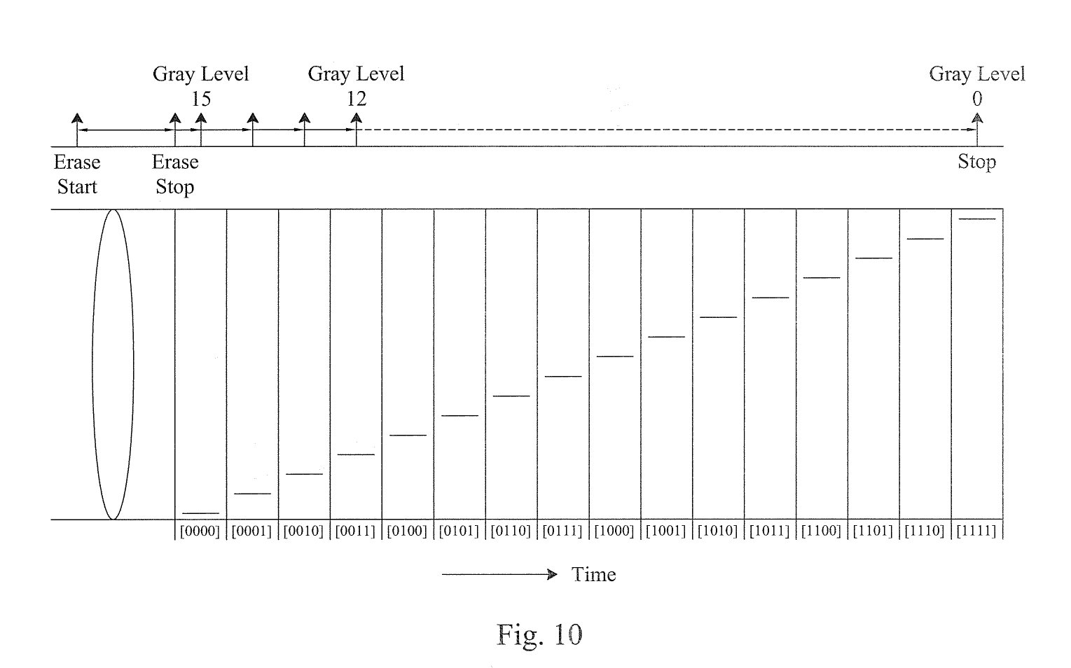

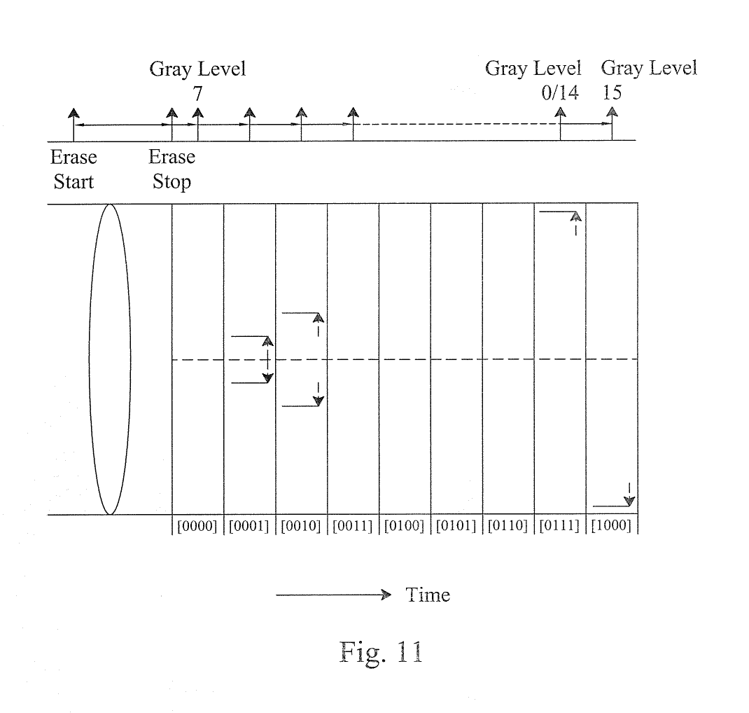

FIG. 6 is a flowchart of a picture update method in an embodiment according to the present invention. Referring to FIGS. 1 and 6, for updating a picture, step Si is first performed to erase the ghost image, in which the timing controller 14 turns on several frames to apply a reset voltage pulse to all the pixels 30 of the EPD panel 20, preferably including at least one time of alternative fully black and fully white driving. Then, step S2 is performed to adjust all the pixels 30 to a same gray level, for example, as shown in FIG. 7, to gray level 0, as indicated by the dotted line 44, or to gray level 15, as indicated by the dotted line 46, or to gray level 7, as indicated by the dotted line 48. Referring to FIGS. 1 and 6 again, step S3 is performed to continuously turn on a plurality of frames, in each of the frames only changing one gray level, thereby gradually adjusting all the pixels 30 to their respective desired gray levels. For example, referring to FIG. 8, in order to adjust a pixel 30 to gray level 15, no matter the current gray level of the pixel 30 is which one of gray level 0 to gray level 15, the current gray level is first erased, as shown between the time Erase Start and the time Erase Stop. Then, sixteen frames are continuously turned on, in the manner that the pixel 30 is adjusted to gray level 0 by the first frame, to gray level 1 by the second frame, and so forth, and finally to gray level 15 by the sixteenth frame. As shown in FIG. 8, in a sixteen gray level system, there are sixteen frames required at most for gray level adjustment of all the pixels 30. Even if added with the previous erasing frames, the total number of the frames is still small than that of the conventional driving method, resulting in faster picture updating process and less power consumption. Referring to FIG. 9, the process for adjusting a pixel 30 to gray level 3 is similar to that depicted in FIG. 8, except that since the pixel 30 has reaches gray level 3 after the fourth frame, the subsequent frames apply no more driving voltage to the pixel 30, so the pixel 30 remains at gray level 3 until the sixteenth frame is turned off. The pixels to be adjusted to other gray levels are adjusted in the same manner, where once a pixel reaches its target gray level, it stops changing, and only those haven't reach their target gray levels keep changing one gray level in each subsequent frame. Since the pixels with lower target gray levels stop changing earlier, the system is more beneficial for saving power. FIG. 10 shows another case, where all the pixels 30 after erasing are adjusted to gray level 15, and then change one gray level in each frame. In this case, the pixel targeting gray level 0 reaches gray level 0 after sixteenth frames. In FIG. 11, all the pixels 30 are adjusted to gray level 7 after erasing, and then a plurality of frames are continuously turned on to adjust one gray level in each frame. The pixels with their targets lower than gray level 7 decline one gray level in each frame, while the pixels with their targets higher than gray level 7 rise one gray level in each frame, which will further reduce the number of the frames.

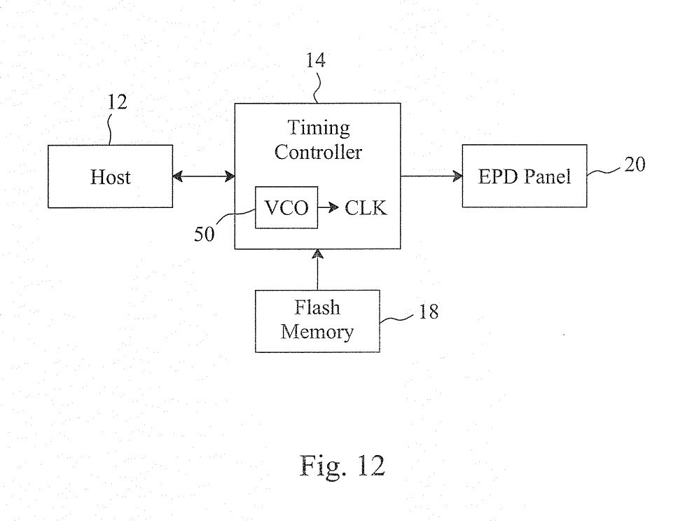

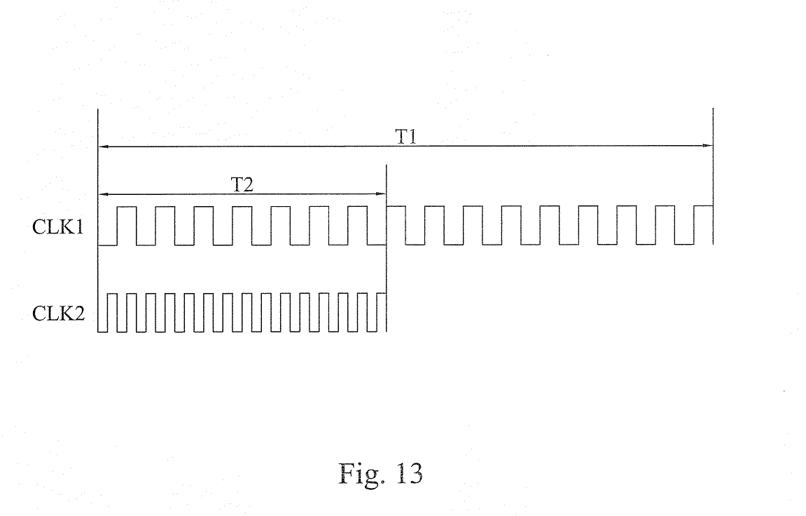

As described above, the displacement of the electrophoretic particles depends on the voltage pulse. In the event that the higher the applied driving voltage is, the shorter the required pulse length is, and vice versa. Furthermore, since the characteristic curve of dL* is nonlinear, the time length required to change one gray level may vary with the start gray level under a same applied driving voltage. Therefore, different frames may have different time lengths and/or require different driving voltages. The time length and driving voltage for each frame are designed by the system designer. Nonetheless, in one system, the time length of each frame is generated according to the system clock, and this feature is useful in adjusting lightness difference between gray levels of an EPD panel. Since each frame changes only one gray level, under a same driving voltage, changing the time length of a frame will change the lightness difference between two adjacent gray levels. As shown in FIG. 12, the timing controller 14 includes a voltage controlled oscillator (VCO) 50 for providing a system clock CLK, which is the basis for determining the time length of a frame. For adjusting the lightness of the EPD panel 20, the system clock CLK may be adjusted in frequency, so that the time length of each frame is changed. For instance, as shown in FIG. 13, the system clock turns to CLK2 from CLK1, so the frequency is increased, thereby shortening the time length of each frame applied to the EPD panel 20, and in turn shortening the moving time of the electrophoretic particles during each frame. That is, the electrophoretic particles are driven by the same voltage yet their displacement is reduced. Referring to the equation Eq-1, reduction in the time t leads to smaller lightness difference between the gray levels, so the fineness of each gray level can be altered by adjusting the frequency of the system clock CLK.

In another embodiment, the frequency of the system clock CLK remains unchanged while the numbers of clock count corresponding to each frame are changed. For instance, reducing the time length of a frame from fifty pulse counts to forty pulse counts, 20% reduction of the time length is made.

The content size of the lookup table is herein reviewed. In a sixteen gray level system, the lookup table has merely to store the driving waveforms for sixteen frames. Assuming that the frequency of each frame takes 4 bits, then the lookup table has a content size of 16×4÷8=8 bytes, far smaller than a conventional lookup table in content size.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An electrophoretic display comprising:
an electrophoretic display panel having a plurality of pixels;
a timing controller connected to the electrophoretic display panel; and
a flash memory connected to the timing controller, storing driving waveforms for the plurality of pixels to change one gray level;
wherein when updating picture, the timing controller reads out a required one of the driving waveforms from the flash memory, and generates a control signal accordingly for the electrophoretic display panel to adjust one gray level of at least one of the plurality of pixels.

2. A picture update method of an electrophoretic display, comprising the steps of:
A. erasing a ghost image; and
B. continuously turning on a plurality of frames, each for changing only one gray level, so as to gradually adjust pixels needed to update into their respective desired gray levels.

3. The picture update method of claim 2, wherein the step A comprises the step of applying a reset voltage pulse to all pixels of the electrophoretic display.

4. The picture update method of claim 2, wherein the step B comprises the step of first adjusting all pixels of the electrophoretic display to a same gray level.

5. The picture update method of claim 2, wherein the step B comprises the step of first adjusting all pixels of the electrophoretic display to a gray level representing fully black.

6. The picture update method of claim 2, wherein the step B comprises the step of first adjusting all pixels of the electrophoretic display to a gray level representing fully white.

7. The picture update method of claim 2, wherein the step B comprises the step of first adjusting all pixels of the electrophoretic display to a gray level between a gray level representing fully black and a gray level representing fully white.

8. The picture update method of claim 2, further comprising the step of adjusting a time length of the plurality of frames.

9. The picture update method of claim 2, further comprising the step of adjusting a frequency of a system clock, so as to adjust a time length of the plurality of frames.

10. The picture update method of claim 2, further comprising the step of adjusting a number of a clock count corresponding to each frame, so as to adjust a time length of the plurality of frames.
